(19) United States
(12) Patent Application Publication
(10) Pub. No.: US 2006/0091752 A1
(43) Pub. Date: May 4, 2006

(54) Electric motor and electric compressor

(76) Inventors: Taku Adaniya, Kariya-shi (JP); Minoru Mera, Kariya-shi (JP); Kiyoshi Uetsuji, Kariya-shi (JP)

Correspondence Address: MORGAN & FINNEGAN, L.L.P., 3 World Financial Center, New York, NY, 10281-2101, US

(21) Appl. No.: 11/265,458

(22) Filed: Nov. 1, 2005

(30) Foreign Application Priority Data
Nov. 4, 2004 (JP) P2004-320882

(51) Int. Cl. B60H 1/32; H02K 21/12; F04B 1/26

(52) U.S. Cl. 310/156.16; 310/261; 417/222.1; 62/133

(57) ABSTRACT

An electric motor includes a stator and a rotor disposed surrounding the stator and being rotatable around the stator. The rotor has a plurality of permanent magnets each of which is movable in a radial direction of the rotor. The radially outward movement of the permanent magnets is urged by centrifugal force caused by the rotation of the rotor.

### BACKGROUND

The present invention relates to an electric motor and an electric compressor.

The electric motor is operable under a condition where the sum of induced voltage and voltage drop in the electric motor (due to current flowing in a coil of the electric motor) is the same as or below the output voltage from an inverter to the electric motor. The induced electromotive force (or induced voltage) of the electric motor is determined by the magnetic flux caused by permanent magnet provided in a rotor of the electric motor and angular velocity of the electric motor. That is, the induced voltage of the electric motor increases in proportion to increasing of the angular velocity of the electric motor. As the induced voltage becomes dominant, the electric current that can be supplied to the electric motor is reduced. Since the torque generated by the electric motor is increased in proportional to increasing of the electric current supplied to the motor, it is difficult for the motor to generate a high torque in a high-speed region of the electric motor in which the induced voltage becomes dominant.

To solve the above problem, some electric motors use means for expanding the high-speed region of the electric motor in which high torque operation can be achieved by weak field control. According to this prior art, however, it is necessary to increase the electric current for the weak field control in accordance with the magnitude of the induced electromotive force which increases in proportion to the angular velocity of the electric motor and, therefore, the operating efficiency of the electric motor deteriorates in its high-speed region.

An inner rotor type electric motor disclosed by Japanese Unexamined Patent Publication No. 7-288940 shows means for expanding the high-speed region of the electric motor in which high torque operation can be achieved without using the weak filed control. In this electric motor, a sub magnet is interposed between N and S poles of any two adjacent main magnets of the rotor in such a way that the sub magnet is radially movable by centrifugal force.

The inner rotor type electric motor, which is disclosed by the above-cited Japanese Unexamined Patent Publication No. 7-288940, is capable of avoiding the deterioration of efficiency of the electric motor in its high-speed region.

### SUMMARY

The present invention is directed to an outer rotor type electric motor whose high-speed rotation region (in which high torque operation can be achieved) is expanded without using the weak field control.

The present invention provides an electric motor which includes a stator and a rotor disposed surrounding the stator and rotatable around the stator. The rotor has a plurality of permanent magnets each of which is movable in a radial direction of the rotor. The radially outward movement of the permanent magnets is urged by centrifugal force caused by the rotation of the rotor.

The present invention also provides an electric compressor which includes a rotary shaft, an electric motor for driving the rotary shaft and a compression operation body. The electric motor has a stator disposed around the rotary shaft and a rotor disposed surrounding the stator and connected to the rotary shaft for rotation therewith. The rotor has a plurality of permanent magnets each of which is movable in a radial direction of the rotor. The radially outward movement of the permanent magnets is urged by centrifugal force caused by the rotation of the rotor. The compression operation body is operatively connected to the rotary shaft for compressing and discharging gas in a compression chamber caused by the rotation of the rotary shaft.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention, together with objects and advantages thereof, may best be understood by reference to the following description of the presently preferred embodiments, together with the accompanying drawing, in which:

FIG. 1 is longitudinal sectional view showing a compressor according to a first preferred embodiment of the present invention;

FIG. 2A is a partial cross sectional view taken on line A-A of FIG. 1 in the state where a permanent magnet of an electric motor of the compressor is placed closest to a stator of the electric motor;

FIG. 2B is a partial cross sectional view taken on line A-A of FIG. 1 in the state where the permanent magnet is moved away from the state where the permanent magnet is placed closest to the stator;

FIG. 3A shows another embodiment of the present invention in the state where a permanent magnet of an electric motor of a compressor is placed closest to a stator of the electric motor; and

FIG. 3B shows another embodiment of the present invention in the state where the permanent magnet is moved away from the state where the permanent magnet is placed closest to the stator.

### DETAILED DESCRIPTION OF THE PREFERRED EMBODIMENTS

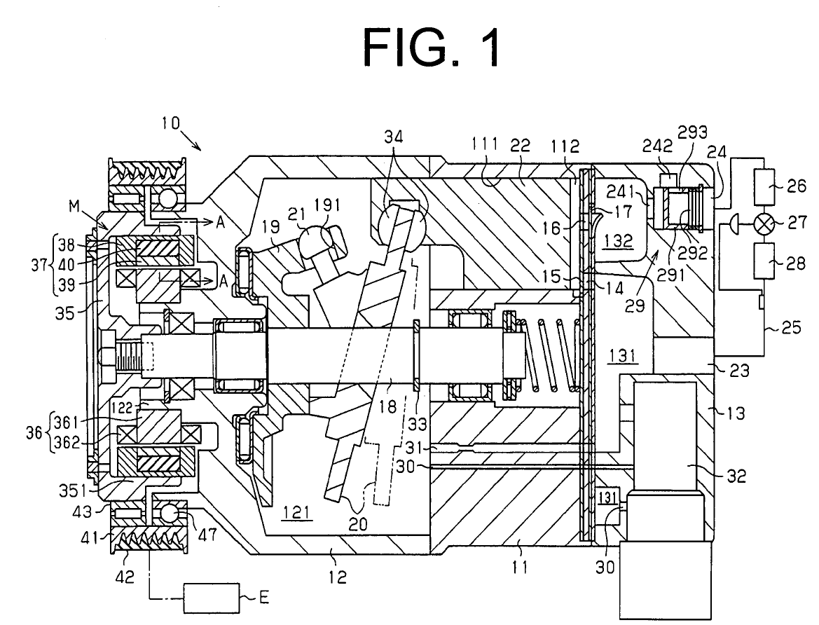

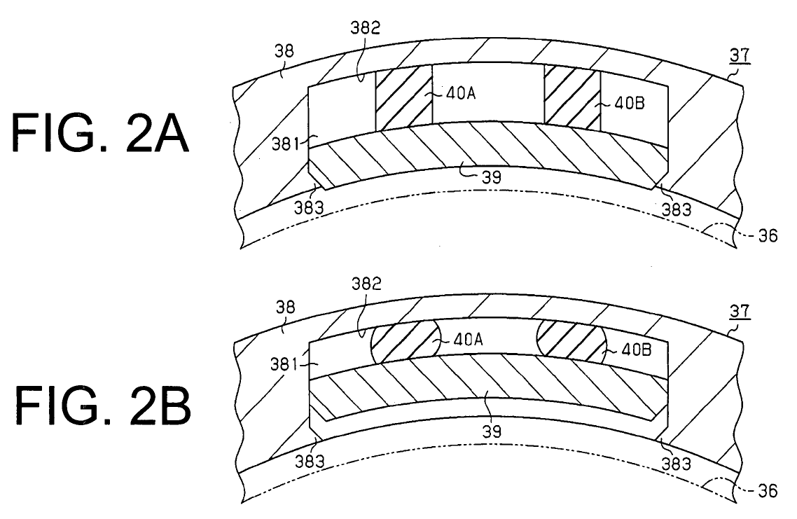

The following will describe a first preferred embodiment of the present invention as applied to a variable displacement compressor with reference to FIGS. 1, 2A and 2B.

Referring to FIG. 1, the compressor 10 has a cylinder block 11, a front housing 12 and a rear housing 13 as a housing. The cylinder block 11 and the front housing 12 define a crank chamber 121 and rotatably support a rotary shaft 18 therein. A lug plate 19 is fixed on the rotary shaft 18 for rotation therewith and a swash plate 20 is supported by the rotary shaft 18 in such a way that it is capable of sliding in the axial direction of the rotary shaft 18 and of inclining relative to the axial direction. A pair of guide pins 21 is fixed to the swash plate 20 and fitted slidably into a pair of guide holes 191 formed in the lug plate 19, respectively. The swash plate 20 is guided in such a way that the guide pins 21 slide in the guide holes 191 and that the swash plate 20 slides on the rotary shaft 18. The swash plate 20 is rotated integrally with the rotary shaft 18.

The maximum inclination of the swash plate 20, which is shown by solid line in FIG. 1, is regulated by contacting the swash plate 20 with the lug plate 19. The minimum inclination of the swash plate 20 is regulated by contacting the swash plate 20 with a circlip 33 which is mounted on the rotary shaft 18 and this position of the swash plate 20 is shown by chain double-dashed line in FIG. 1.

The rotation of the swash plate 20 which is driven by the rotary shaft 18 is converted into a reciprocating movement of a piston 22 in a cylinder bore 111 of the cylinder block 11 through a pair of shoes 34 in a manner well known in the art. A compression chamber 112 is defined in the cylinder bore 111.

The rear housing 13 includes therein a suction chamber 131 and a discharge chamber 132. Refrigerant gas in the suction chamber 131 is drawn into the compression chamber 112 through a suction port 14 and a suction valve 15 by suction stroke of the piston 22 (the movement of the piston 22 from the right side to the left side as seen in FIG. 1 or suction operation of the piston 22). The refrigerant gas in the compression chamber 112 is compressed and discharged into the discharge chamber 132 through a discharge port 16 and a discharge valve 17 by compression and discharge stroke of the piston 22 (the movement of the piston 22 from the left side to the right side in FIG. 1 or compression operation of the piston 22). The piston 22 serves as a compression operation body for compressing and discharging the refrigerant gas in the compression chamber 112.

The rear housing 13 includes therein a suction passage 23 through which the refrigerant gas before compression is introduced into the suction chamber 131 and a discharge passage 24 through which compressed refrigerant gas is discharged out of the discharge chamber 132. The suction passage 23 and the discharge passage 24 are connected by an external refrigerant circuit 25 which includes a condenser 26 for removing heat from the compressed refrigerant gas, an expansion valve 27 and an evaporator 28 for allowing the refrigerant to absorb the ambient heat.

A valve 29 is disposed in the discharge passage 24. The valve 29 has a cylindrical valve body 291 which is urged by a compression spring 292 in the direction which closes a port 241 of the discharge passage 24. When the valve body 291 is positioned as shown in FIG. 1 and the port 241 is opened, the refrigerant gas in the discharge chamber 132 is flowed into the external refrigerant circuit 25 through the port 241, a detour 242, a through hole 293 and the interior of the valve body 291. In the state where the valve body 291 closes the port 241, the flow of the refrigerant gas from the discharge chamber 132 into the external refrigerant circuit 25 is blocked.

Part of the refrigerant gas in the discharge chamber 132 flows into the crank chamber 121 through a supply passage 30. The refrigerant gas in the crank chamber 121 is flowed into the suction chamber 131 through a bleed passage 31. An electromagnetic displacement control valve 32, which is operable to control the suction pressure of the refrigerant gas in accordance with the value of current supplied to the control valve 32, is disposed in the supply passage 30.

Specifically, when the value of the current supplied to the control valve 32 is increased, an opening amount of the control valve 32 is decreased thereby to decrease the amount of refrigerant gas flowing from the discharge chamber 132 to the crank chamber 121. Meanwhile, the amount of refrigerant gas in the crank chamber 121 flows into the suction chamber 131 through the bleed passage 31. Therefore, as the amount of refrigerant gas supplied into the crank chamber 121 is decreased, the pressure in the crank chamber 121 is decreased and the swash plate 20 is then moved so as to increase its inclination relative to the rotary shaft 18 thereby to increase the displacement of the compressor. When the value of current supplied to the control valve 32 is decreased, on the other hand, the opening amount of the control valve 32 is increased thereby to increase the amount of refrigerant gas flowing from the discharge chamber 132 to the crank chamber 121. Therefore, the pressure in the crank chamber 121 is increased, with the result that the inclination of the swash plate 20 is decreased and the displacement of the compressor is decreased, accordingly.

When the value of current supplied to the control valve 32 becomes zero, the opening amount of the control valve 32 is maximized thereby to minimize the inclination of the swash plate 20. An urging force of the compression spring 292 is set so that when the inclination of the swash plate 20 is at its minimum, a force caused by the pressure in the discharge passage 24 upstream of the valve 29 is below the sum of a force caused by the pressure in the discharge passage 24 downstream of the valve 29 and the urging force of the compression spring 292. Therefore, when the inclination of the swash plate 20 is minimized, the valve body 291 closes the port 241 to stop the refrigerant circulation in the external refrigerant circuit 25. The state where the refrigerant circulation is stopped is a state where reduction of heat load is stopped.

The rotary shaft 18 protrudes outward from a cylindrical portion 122 of the front housing 12. On the protruding end of the rotary shaft 18 is fixed a hub 35. A pulley 41 is rotatably supported by a radial bearing 47 which is mounted on the front housing 12. A belt 42 is wound around the pulley 41 and a drive pulley (not shown) of a vehicle engine E serving as an external drive source. A one-way clutch 43 is interposed between the pulley 41 and a flange 351 of the hub 35. The torque of the vehicle engine E is transmitted to the rotary shaft 18 through the belt 42, the pulley 41, the one-way clutch 43 and the hub 35 thereby to cause the rotary shaft 18 and the swash plate 20 to be rotated integrally with each other.

An electric motor M is mounted on the rotary shaft 18 between the flange 351 of the hub 35 and the cylindrical portion 122 of the front housing 12. A rotor 37 of the motor M is mounted on the flange 351 and a stator 36 of the motor M is mounted on the cylindrical portion 122 of the front housing 12. The stator 36 has a plurality of stator cores 361 each having a coil 362 wound therearound. The rotor 37 is rotatable by energization of the coil 362. The hub 35, the rotary shaft 18 and the swash plate 20 are rotatable integrally with the rotation of the rotor 37. The rotational speed of the compressor 10 (or the rotational speed of the rotary shaft 18) coincides with that of the electric motor M.

The coil 362 is energizable when the vehicle engine E is at a stop. Because of the aforementioned one-way clutch 43, the torque of the electric motor M (or the torque of the rotor 37) is prevented from being transmitted to the vehicle engine E.

As shown in FIGS. 2A and 2B, the rotor 37 has an annular rotor core 38 including a plurality of guide holes 381 in the inner periphery thereof, a permanent magnet 39 disposed in each guide hole 381, and a pair of elastic bodies 40A, 40B interposed between the bottom 382 of the guide hole 381 and its permanent magnet 39. The elastic bodies 40A, 40B are made of rubber, and fixed to either the bottom 382 of the guide hole 381 or the permanent magnet 39. The guide holes 381 each having therein the permanent magnet 39 and the elastic bodies 40A, 40B are formed at substantially the same intervals along the periphery of the rotor core 38. That is, the permanent magnets 39 are disposed in the respective guide holes 381 at a predetermined interval along the periphery of the rotor core 38. The permanent magnets 39 are disposed along the periphery of the rotor core 38 in such a way that any two adjacent permanent magnets 39 have different magnetic poles on the side of the stator 36.

The rotor core 38 has an engaging portion 383 formed at the opening end of the guide hole 381 for preventing the permanent magnet 381 from disengaging from the guide hole 381 and also for regulating the position at which the permanent magnet 39 is placed closest to the peripheral surface of the stator 36.

FIG. 2A shows a state where the electric motor M is at a stop. In this state, the elastic bodies 40A, 40B are elastically deformed, and the elastic force caused by the elastic deformation of the elastic bodies 40A, 40B presses the permanent magnet 39 against the engaging portion 383. That is, a predetermined preload is applied to each permanent magnet 39 by the elastic bodies 40A, 40B to regulate the position of the permanent magnet 39 closest to the peripheral surface of the stator 36.

FIG. 2B shows a state where the electric motor M is rotated at a high speed. Each permanent magnet 39 is urged radially outward of the rotor 37 by the centrifugal force caused by the rotation of the rotor 37. When the centrifugal force acting on the permanent magnet 39 of the rotor 37 exceeds the magnitude of the preload of the elastic bodies 40A, 40B, the permanent magnet 39 is moved radially outward. In the state of FIG. 2B, each permanent magnetic 39 is moved away from the engaging portion 383, and the elastic bodies 40A, 40B in FIG. 2B are elastically deformed greater than that in FIG. 2A.

The pairs of elastic bodies 40A, 40B provide an elastically urging means for urging the permanent magnets 39 radially inward of the rotor 37 and also a preload applying means for applying the preload to the permanent magnets 39.

The first embodiment of the present invention has the following advantageous effects.

(1-1) When the rotational speed of the electric motor M becomes to a high-speed region, all the permanent magnets 39 are moved away from their position closest to the stator 36 shown in FIG. 2A. Therefore, maximum value of the magnetic flux is reduced, and the magnitude of induced electromotive force during high-speed rotation of the electric motor M is controlled, accordingly. That is, the electric motor M is capable of expanding the high-speed region in which high-torque operation is performed, thereby avoiding deterioration of its efficiency.

(1-2) When the centrifugal force acting on the permanent magnet 39 exceeds the preload, the permanent magnets 39 are moved radially outward of the rotor 37. Selecting the magnitude of the preload to the magnets 39, the rotational speed at which the electric motor M starts to control the magnitude of induced electromotive force is appropriately selected. Such setting of the preload is preferable when the magnitude of induced electromotive force is appropriately controlled in accordance with the rotational speed of the electric motor M.

(1-3) The elastic bodies 40A, 40B which are made of rubber are suitable elastically urging means for preloading the permanent magnets 39 because the elastic bodies 40A, 40B occupy only a small space.

(1-4) The guide hole 381, which is formed to permit the permanent magnet 39 to be guided slidably in the radial direction of the rotor 37, is suitable for disposing therein the elastically urging means (or the pair of elastic bodies 40A, 40B). The structure of the guide hole 381 in which the pair of elastic bodies 40A, 40B is interposed between the bottom 382 and the permanent magnet 39 is advantageously simple for preloading the pair of elastic bodies 40A, 40B.

(1-5) When the swash plate 20 is rotated at the high speed and at its maximum inclination, the discharge pressure is high, and the load torque applied to the compressor is large, accordingly. For a compressor operating at a high speed and with a large load torque, the electric motor M which is operable to generate a high torque is suitable as a drive source of the compressor.

The present invention can be practiced in various changes and modifications as exemplified below.

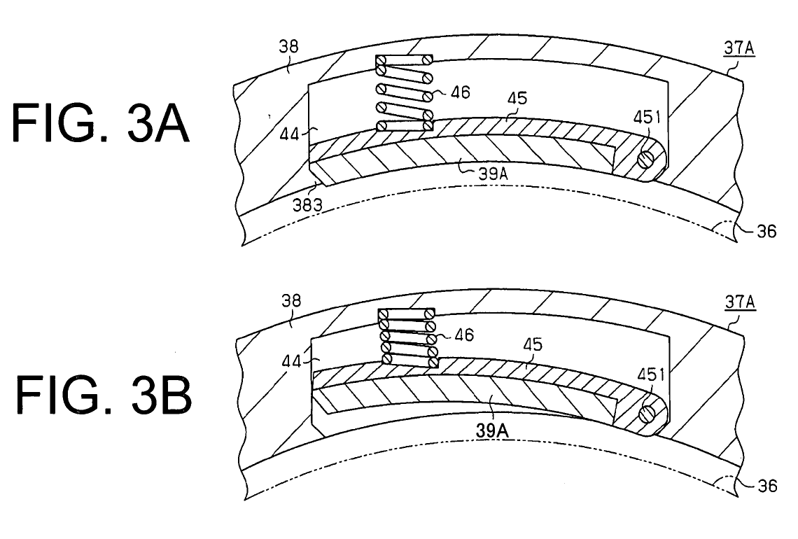

(1) In a modified embodiment, the rotor core 38 of a rotor 37A includes a guide hole 44 in the inner periphery thereof. A permanent magnet 39A is fixed to a lever 45 which is disposed in the guide hole 44, as shown in FIGS. 3A and 3B. A compression spring 46 is interposed between the lever 45 and the bottom of the guide hole 44. The lever 45 is pivotable on a shaft 451.

FIG. 3A shows a state where the electric motor M is at a stop and urging force of the compression spring 46 urges the permanent magnet 39A against the engaging portion 383 of the rotor core 38. That is, a predetermined preload is applied to the permanent magnet 39A by the urging force of the compression spring 46 to regulate the position of the permanent magnet 39 closest to the stator 36.

FIG. 3B shows a state where the electric motor M is rotated at a high speed and the permanent magnet 39A is moved or pivoted away from the engaging portion 383 by the centrifugal force caused by the high-speed rotation of the rotor 37A. The permanent magnet 39A is urged radially outward of the rotor 37A by the centrifugal force caused by the rotation of the rotor 37A. When the centrifugal force acting on the permanent magnet 39A of the rotor 37A exceeds the magnitude of the preload of the compression spring 46, the permanent magnet 39A is pivoted on the shaft 451 radially outward of the rotor 37A.

The compression springs 46 provide an elastically urging means for urging the permanent magnets 39A radially outward of the rotor 37A and also a preload applying means for applying the preload to the permanent magnets 39A.

(2) In another modified embodiment, a coiled compression spring may be employed instead of the elastic bodies 40A, 40B made of rubber.

(3) The present invention may be applied to a fixed displacement type electric compressor.

Therefore, the present examples and embodiments are to be considered as illustrative and not restrictive and the invention is not to be limited to the details given herein but may be modified.

What is claimed is:

1. An electric motor comprising:
a stator; and
a rotor disposed surrounding the stator and rotatable therearound, the rotor having a plurality of permanent magnets each of which is movable in a radial direction of the rotor, wherein the radially outward movement of the permanent magnets is urged by centrifugal force caused by the rotation of the rotor.

2. The electric motor according to claim 1, wherein the rotor has a preload applying means for urging the permanent magnets radially inward of the rotor, thereby applying preload to the permanent magnets.

3. The electric motor according to claim 2, wherein the preload applying means is an elastically urging means for urging the permanent magnets radially inward of the rotor by elastic force.

4. The electric motor according to claim 3, wherein the elastically urging means includes a pair of elastic bodies.

5. The electric motor according to claim 3, wherein the elastically urging means includes a compression spring.

6. The electric motor according to claim 3, wherein the rotor has an annular rotor core including in an inner periphery thereof a plurality of guide holes in each of which the permanent magnets are disposed, respectively, the guide holes allowing the permanent magnets to be guided slidably in the radial direction of the rotor, the elastically urging means being interposed between the permanent magnets and bottoms of the guide holes.

7. The electric motor according to claim 6, wherein the rotor core has an engaging portion formed at an opening end of each of the guide holes for preventing each of the permanent magnets from disengaging from each of the guide holes and also regulating the position at which each of the permanent magnets is placed closest to a peripheral surface of the stator.

8. An electric compressor comprising:
a rotary shaft;
an electric motor for driving the rotary shaft comprising;
a stator disposed around the rotary shaft; and
a rotor disposed surrounding the stator and connected to the rotary shaft for rotation therewith, the rotor having a plurality of permanent magnets each of which is movable in a radial direction of the rotor, wherein the radially outward movement of the permanent magnets is
urged by centrifugal force caused by the rotation of the rotor;
a compression operation body operatively connected to the rotary shaft for compressing and discharging gas in a compression chamber caused by the rotation of the rotary shaft.

9. The electric compressor according to claim 8, wherein the rotor has a preload applying means for urging the permanent magnets radially inward of the rotor, thereby applying preload to the permanent magnets.

10. The electric compressor according to claim 9, wherein the preload applying means is an elastically urging means for urging the permanent magnets radially inward of the rotor by elastic force.

11. The electric compressor according to claim 10, wherein the elastically urging means includes a pair of elastic bodies.

12. The electric compressor according to claim 10, wherein the elastically urging means includes a compression spring.

13. The electric compressor according to claim 10, wherein the rotor has an annular rotor core including in an inner periphery thereof a plurality of guide holes in each of which the permanent magnets are disposed, respectively, the guide holes allowing the permanent magnets to be guided slidably in the radial direction of the rotor, the elastically urging means being interposed between the permanent magnets and bottoms of the guide holes.

14. The electric compressor according to claim 13, wherein the rotor core has an engaging portion formed at an opening end of each of the guide holes for preventing each of the permanent magnets from disengaging from each of the guide holes and also regulating the position at which each of the permanent magnets is placed closest to a peripheral surface of the stator.

15. The electric compressor according to claim 8, wherein the compressor is a variable displacement compressor.
